(19) United States
(12) Patent Application Publication
(10) Pub. No.: US 2022/0042483 A1
(43) Pub. Date: Feb. 10, 2022

(54) FUEL HEATER

(71) Applicant: AISIN CORPORATION, Kariya (JP)

(72) Inventors: Tomohiro YAMAGUCHI, Kariya-shi (JP); Masato ISHII, Kariya-shi (JP); Hideto YANO, Kariya-shi (JP); Kazuyoshi SHIMATANI, Kariya-shi (JP); Takahiko AOYAGI, Kariya-shi (JP); Masahiro KUROKI, Kariya-shi (JP)

(73) Assignee: AISIN CORPORATION, Kariya (JP)

(21) Appl. No.: 17/385,125

(22) Filed: Jul. 26, 2021

(30) Foreign Application Priority Data
Aug. 7, 2020 (JP) 2020-134688

(51) Int. Cl. F02M 53/06; F02N 11/08

(52) U.S. Cl. CPC F02M 53/06; F02M 2700/077; F02N 2200/061; F02N 11/0829

(57) ABSTRACT

A fuel heater including an engine that is driven by combustion of air-fuel mixture including air and fuel supplied to a combustion chamber within a cylinder, a battery that stores electricity, and a motor that drives the engine by the electricity supplied from the battery, the fuel heater includes a fuel heating portion heating the fuel with the electricity supplied from the battery, and a controller performing one of a first control by increasing the amount of electricity supplied from the battery to the fuel heating portion and a second control by increasing heating time of the fuel by the fuel heating portion for a time period until the engine starts in a case where a battery charge remaining of the battery is equal to or smaller than a remaining threshold value at a start of the engine.

### CROSS REFERENCE TO RELATED APPLICATIONS

This application is based on and claims priority under 35 U.S.C. § 119 to Japanese Patent Application 2020-134688, filed on Aug. 7, 2020, the entire content of which is incorporated herein by reference.

### TECHNICAL FIELD

This disclosure generally relates to a fuel heater.

### BACKGROUND DISCUSSION

A known fuel heater including a fuel heating portion that heats fuel is disclosed in JPH04-132846A (which is hereinafter referred to as Reference 1), for example.

Reference 1 discloses a fuel supply apparatus (fuel heater) of an internal combustion engine including a positive temperature coefficient (PTC) heater (fuel heating portion) for heating fuel. The aforementioned fuel supply apparatus includes a controller for controlling electric power supplied to the PTC heater so that the PTC heater preheats the fuel. The PTC heater preheats the fuel at the start of the internal combustion engine by a starter motor, which enhances evaporation of the fuel to improve starting performance of the internal combustion engine.

The aforementioned controller is configured to adjust power supply to the PTC heater from a battery in accordance with electric power supplied to the starter motor at the start of the internal combustion engine by the starter motor. Specifically, the controller is configured to control the power supplied to the PTC heater from the battery to decrease in a case where the power supplied to the starter motor and the PTC heater exceeds power supply capacity of the battery, based on battery voltage before the start of the internal combustion engine.

When the power supplied to the PTC heater from the battery decreases in the aforementioned power supply apparatus, the temperature of the PTC heater may excessively decrease at the start of the internal combustion engine by the starter motor. The fuel may be thus not sufficiently vaporized by the PTC heater at the start of the engine when the power supplied to the PTC heater from the battery decreases for the purposes of avoiding the power supplied to the starter motor and the PTC heater from exceeding the supply capacity of the battery.

A need thus exists for a fuel heater which is not susceptible to the drawback mentioned above.

### SUMMARY

According to an aspect of this disclosure, a fuel heater including an engine that is driven by combustion of air-fuel mixture including air and fuel supplied to a combustion chamber within a cylinder, a battery that stores electricity, and a motor that drives the engine by the electricity supplied from the battery, the fuel heater includes a fuel heating portion heating the fuel with the electricity supplied from the battery, and a controller performing one of a first control by increasing the amount of electricity supplied from the battery to the fuel heating portion and a second control by increasing heating time of the fuel by the fuel heating portion for a time period until the engine starts in a case where a battery charge remaining of the battery is equal to or smaller than a remaining threshold value at a start of the engine.

According to another aspect of this disclosure, a fuel heating system includes an engine that is driven by combustion of air-fuel mixture including air and fuel supplied to a combustion chamber within a cylinder, a battery that stores electricity, and a motor that drives the engine by electricity supplied from the battery, and a fuel heater that heats the fuel supplied to the combustion chamber within the cylinder of the engine with the electricity supplied from the battery, the fuel heater including the fuel heating portion heating the fuel with the electricity supplied from the battery, the heating control portion controlling the electricity supplied to the fuel heating portion, and an engine control portion performing one of a first control by increasing the amount of electricity supplied from the battery to the fuel heating portion and a second control by increasing heating time of the fuel by the fuel heating portion for a time period until the engine starts in a case where the battery charge remaining of the battery is equal to or smaller than the remaining threshold value at a start of the engine.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of an engine where a fuel heater is mounted according to a first embodiment disclosed here;

FIG. 2 is a cross-sectional view of the fuel heater that includes a fuel heating portion mounted at an intake port;

FIG. 3 is a block diagram illustrating an engine control portion and a heating control portion of the fuel heater;

FIG. 4 is a schematic diagram illustrating a battery charge remaining of the fuel heating portion according to the first embodiment;

FIG. 5 is a timing chart of a first heater temperature control of the fuel heater according to the first embodiment;

FIG. 6 is a timing chart of a second heater temperature control of the fuel heater according to the first embodiment;

FIG. 7 is a timing chart of a third heater temperature control of the fuel heater according to the first embodiment;

FIG. 8 is a timing chart of a fourth heater temperature control of the fuel heater according to the first embodiment;

FIG. 9 is a flowchart of a heating control processing performed by the fuel heater according to the first embodiment;

FIG. 10 is a flowchart of a first heating control processing performed by the fuel heater according to the first embodiment;

FIG. 11 is a flowchart of a second heating control processing performed by the fuel heater according to the first embodiment;

FIG. 12 is a flowchart illustrating steps S708 to S710 of an injection control of the fuel heater according to the first embodiment;

FIG. 13 is a flowchart illustrating steps S711 to S716 of the injection control of the fuel heater according to the first embodiment;

FIG. 14 is a cross-sectional view of a fuel heater that includes a fuel heating portion mounted at an intake port according to a second embodiment; and

FIG. 15 is a timing chart of a heater temperature control of the fuel heater according to the second embodiment.

### DETAILED DESCRIPTION

A fuel heater mounted at a vehicle such as a hybrid vehicle and a gasoline vehicle, for example, is explained with reference to the attached drawings.

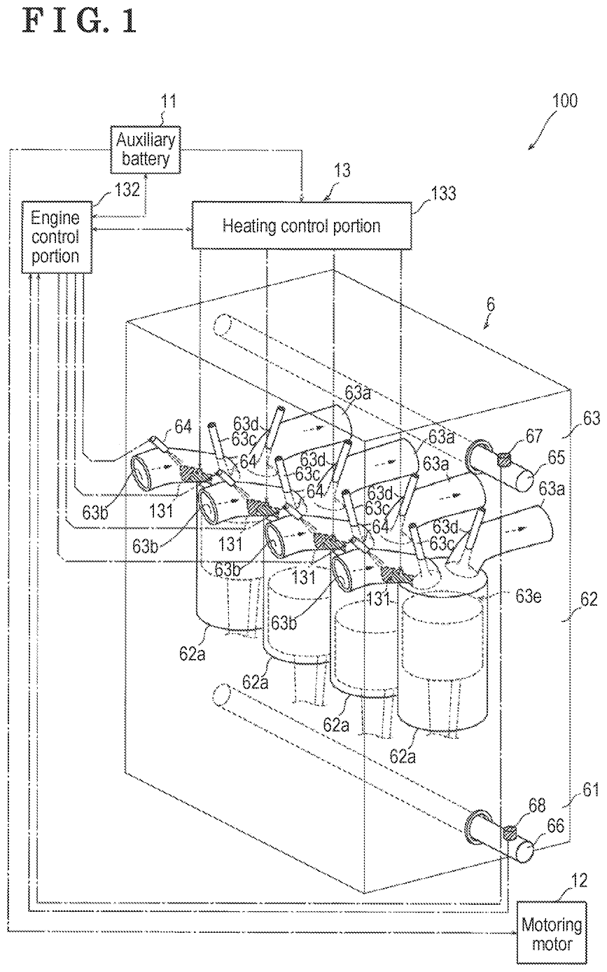

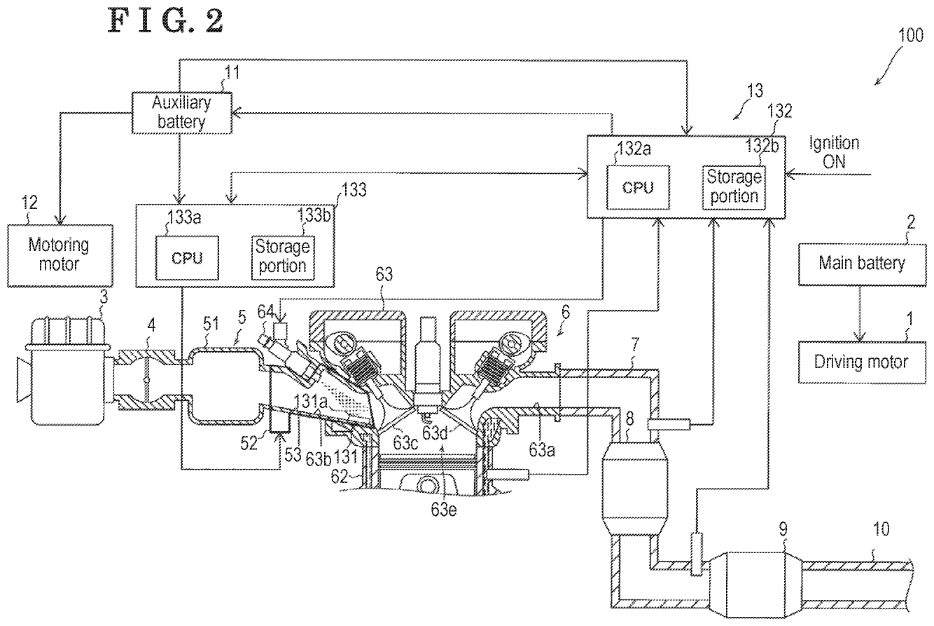

As illustrated in FIGS. 1 and 2, a fuel heater 13 according to a first embodiment is mounted at an electric vehicle 100 such as a hybrid vehicle, for example, serving as an example of a vehicle. The electric vehicle 100 is configured to be driven by driving at least one of an engine 6 and a driving motor 1. The electric vehicle 100 includes the driving motor 1, a main battery 2, an air cleaner 3, a throttle 4, an intake apparatus 5, the engine 6, an exhaust pipe 7, a three-way catalyst 8, a filter 9, and a tail pipe 10.

The driving motor 1 serves as a drive source for generating a driving force that is transmitted to wheels through a power transmission mechanism. The driving motor 1 is driven by electricity supplied from the main battery 2. The main battery 2 stores electricity via a power control unit. The main battery 2 is a secondary battery.

The intake apparatus 5 is configured to supply air to a combustion chamber 63e inside a cylinder 62a. The intake apparatus 5 includes an intake manifold 51, a port portion 52, and an intake passage 53. The port portion 52 is constructed so that fuel injected from an injection opening of an injector 64 is introduced. The intake manifold 51 and the port portion 52 are connected to each other by a fastening member. The intake passage 53 that is provided inside the port portion 52 is configured to flow air-fuel mixture including air and fuel to the cylinder 62a. The injector 64 is configured to spray or inject the fuel in the form of mist to air flowing towards the combustion chamber 63e. The fuel is gasoline, gas fuel, or ethanol, for example. The engine 6 is a port injection engine where the fuel is injected into an intake port 63b.

The engine 6 is driven by combustion of air-fuel mixture supplied to the combustion chamber 63e provided inside the cylinder 62a. The engine 6 is constructed in a manner that a cylinder block 62 is fixed to a crankcase 61 at an upper side thereof and further a cylinder head 63 is fixed to the cylinder block 62 at an upper side thereof.

The cylinder head 63 includes plural (four, in the embodiment) exhaust ports 63a and plural (four, in the embodiment) intake ports 63b connected to the combustion chambers 63e. The port portions 52 are inserted to be positioned within the respective intake ports 63b. Intake valves 63c mounted at the cylinder head 63 are configured to open and close respective intake openings through which the combustion chambers 63e and the plural intake ports 63b are connected to one another. Exhaust valves 63d mounted at the cylinder head 63 are configured to open and close openings through which the combustion chambers 63e and the plural exhaust ports 63a are connected to one another. The plural (four, in the embodiment) cylinders 62a housing respective pistons are provided at the cylinder block 62. The fuel is supplied to the plural cylinders 62a at different timings from one another.

The engine 6 includes plural (four, in the embodiment) injectors 64 for directly injecting the fuel in the form of mist to the respective intake ports 63b, a camshaft 65 driving the intake valves 63c and the exhaust valves 63d, a crankshaft 66, a cam sensor 67, and a crank sensor 68.

The electric vehicle 100 includes an auxiliary battery 11 serving as an example of a battery, a motoring motor 12 serving as an example of a motor, and the fuel heater 13.

The auxiliary battery 11 is configured to store electricity. The auxiliary battery 11 is a secondary battery. The auxiliary battery 11 has a smaller electricity storage capacity than the main battery 2. The auxiliary battery 11 is electrically connected to the motoring motor 12, an engine control portion 132, and the fuel heater 13. The motoring motor 12 is configured to drive and start the engine 6 with the electricity supplied by the auxiliary battery 11. Specifically, the motoring motor 12 is driven with the electricity supplied by the auxiliary battery 11 to drive the crankshaft 66 of the engine 6 (i.e., generate engine cranking) at the time of motoring.

The fuel heater 13 is configured to heat fuel by electricity supplied from the auxiliary battery 11. The fuel heater 13 preheats the fuel supplied to the engine 6. The fuel heater 13 includes a fuel heating portion 131, the engine control portion 132 serving as an example of a controller, and a heating control portion 133 serving as an example of the controller.

The fuel heating portion 131 is configured to heat the fuel by the electricity supplied from the auxiliary battery 11. The fuel heating portion 131 is configured to forcedly heat and vaporize (evaporate) the fuel that has failed to vaporize and adhered to an inner surface of the port portion 52 even when a peripheral temperature is low. The fuel heating portion 131 is constituted by a planar port heater 131a that vaporizes the fuel. The fuel heating portion 131 is arranged at an end portion of the port portion 52. The fuel heating portion 131 includes a heat generator formed by copper, nichrome wire, or stainless, for example, extending linearly.

The engine control portion 132 is configured to drive the engine 6. The engine control portion 132 is constituted by an electronic control unit (ECU) including a central processing unit (CPU) 132a and a storage portion 132b including memory as storage medium. The engine control portion 132 controls each part of the engine 6 by the CPU 132a implementing engine control program stored at the storage portion 132b.

Specifically, the engine control portion 132 is configured to control charge and discharge of the auxiliary battery 11. The engine control portion 132 also controls battery charge remaining R at the time of charge and discharge of the auxiliary battery 11. The battery charge remaining R corresponds to a battery voltage or remaining of battery current when the auxiliary battery 11 is discharged from a fully charged state.

The engine control portion 132 is configured to acquire engine signals including sensor information of a cooling water temperature sensor, an air-fuel ratio sensor, and an O₂ sensor, the battery charge remaining R of the auxiliary battery 11, and various signals from the vehicle. The engine control portion 132 is configured to determine the cylinder 62a in a state before the exhaust stroke or in a state after the exhaust stroke based on a rotation angle position of the camshaft 65 and a rotation angle position of the crankshaft 66. The rotation angle position of the camshaft 65 is measured by the cam sensor 67 and the rotation angle position of the crankshaft 66 is measured by the crank sensor 68.

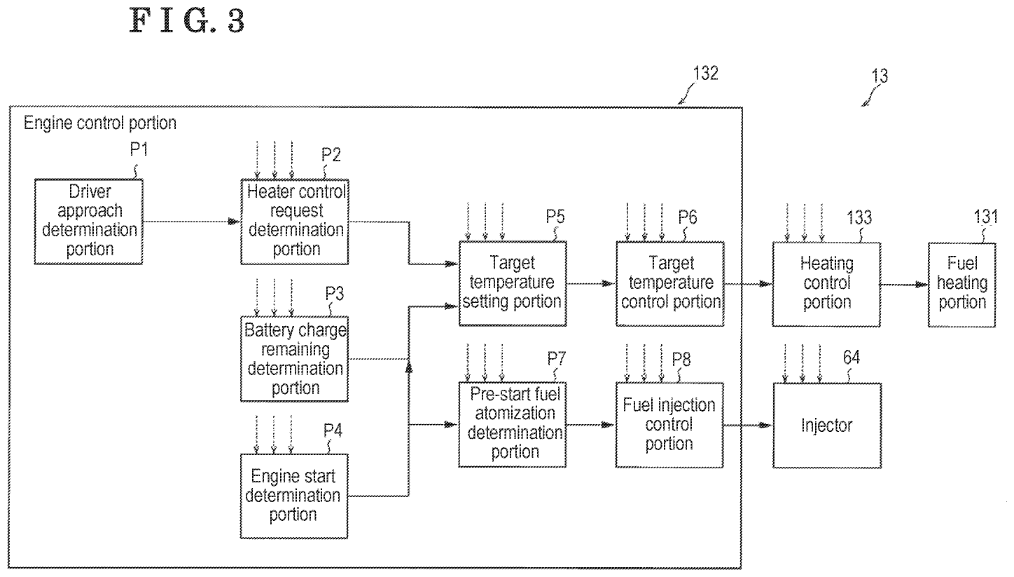

As illustrated in FIG. 3, the engine control portion 132 constituted by the CPU 132a as hardware, for example, includes a driver approach determination portion P1, a heater control request determination portion P2, a battery charge remaining determination portion P3, an engine start determination portion P4, a target temperature setting portion P5, a target temperature control portion P6, a pre-start fuel atomization determination portion P7, and a fuel injection control portion P8 as function blocks of software (engine control program).

The driver approach determination portion P1 includes a function to determine whether a driver of the vehicle 100 is close to the vehicle 100. Specifically, the driver approach determination portion P1 acquires a smart key signal, a door lock signal, a seating signal, a brake pedal signal, and an engine start signal. The driver approach determination portion P1 determines whether the driver is close to the vehicle 100 based on at least one of the aforementioned signals.

The heater control request determination portion P2 includes a function to determine whether to heat the fuel by the fuel heater 13. Specifically, the heater control request determination portion P2 acquires a cooling water temperature, an intake air temperature, an outside temperature or a fuel temperature, a catalyst temperature, engine stop time, an idling stop state (idling time), a catalyst activation state (a measured value of an air-fuel ratio sensor or an O₂ sensor), and an ethanol concentration. The heater control request determination portion P2 determines whether to heat the fuel by the fuel heater 13 based on at least one of the aforementioned information. The aforementioned multiple pieces of information are included in information obtainable from the engine 6 (specifically, from the engine control portion 132 that acquires the engine signals).

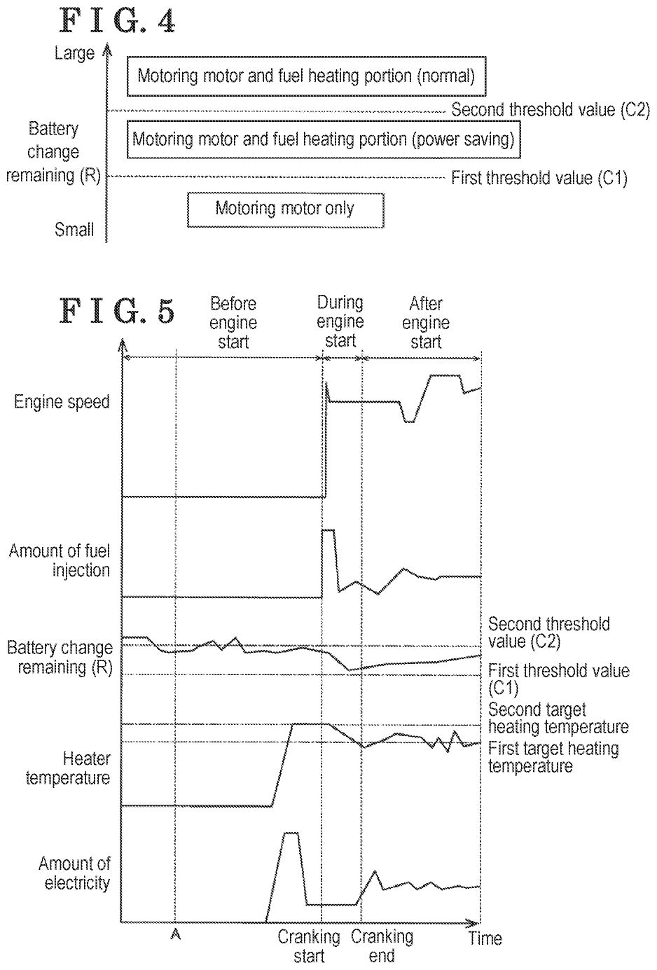

As illustrated in FIGS. 3 and 4, the battery charge remaining determination portion P3 includes a function to acquire the cooling water temperature, the intake air temperature, and the battery charge remaining R. The battery charge remaining determination portion P3 determines whether to heat the fuel by the fuel heater 13 using a map for battery charge remaining based on the aforementioned multiple pieces of information. The map is acquired beforehand.

The battery charge remaining determination portion P3 includes a function to determine whether the motoring motor 12 is able to be driven in accordance with a first threshold value C1 serving as an example of a remaining threshold value. Specifically, the battery charge remaining determination portion P3 determines that the fuel heating portion 131 and the motoring motor 12 are able to be driven on a basis that the battery charge remaining R is equal to or greater than the first threshold value C1. The battery charge remaining determination portion P3 determines that the fuel heating portion 131 is unable to generate heat on a basis that the battery charge remaining R is smaller than the first threshold value C1. The first threshold value C1 is a battery lowest limit serving as a lowest limit of electricity necessary to operate the fuel heating portion 131 and the engine 6 (specifically, the motoring motor 12).

The battery charge remaining determination portion P3 determines whether the fuel heater 13 is able to generate heat in accordance with the first threshold value C1 and a second threshold value C2. The second threshold value C2 is a threshold value for the battery charge remaining R and is greater than the first threshold value C1.

Specifically, the battery charge remaining determination portion P3 determines that the battery charge remaining R is sufficient on a basis that the battery charge remaining R is equal to or greater than the second threshold value C2. The battery charge remaining determination portion P3 then determines that the fuel heating portion 131 is able to generate heat and that the motoring motor 12 is able to be driven with normal electric power (for example, electricity for supplying voltage at approximately 12V for one second).

The battery charge remaining determination portion P3 determines that the battery charge remaining R is not sufficient on a basis that the battery charge remaining R is equal to or greater than the first threshold value C1 and is smaller than the second threshold value C2. The battery charge remaining determination portion P3 then determines that the fuel heating portion 131 is able to generate heat and that the motoring motor 12 is able to be driven with reduced electricity (power saving) lower than the aforementioned normal electric power.

As illustrated in FIG. 3, the engine start determination portion P4 includes a function to determine whether the engine 6 has not yet started (before the start of cranking, before starting), the engine 6 is starting (i.e., cranking), or the engine 6 has already started (after the end of cranking, after the starting). Specifically, the engine start determination portion P4 acquires the engine speed (revolutions of the engine). The engine start determination portion P4 determines whether the engine 6 is in a state before the starting, during the starting, or after the starting in accordance with the engine speed.

The target temperature setting portion P5 includes a function to specify a target heating temperature of the fuel heating portion 131.

Specifically, the target temperature setting portion P5 acquires the determination result of the heater control request determination portion P2. The target temperature setting portion P5 specifies the target heating temperature of the fuel heating portion 131 in a case where the heater control request determination portion P2 determines that heating by the fuel heating portion 131 is necessary. The target temperature setting portion P5 also acquires the determination result of the battery charge remaining determination portion P3. The target temperature setting portion P5 specifies the target heating temperature of the fuel heating portion 131 in a case where the battery charge remaining determination portion P3 determines that heating by the fuel heating portion 131 is capable (available). The target temperature setting portion P5 further acquires the determination result of the engine start determination portion P4 of whether the engine 6 has not yet started, the engine 6 is starting (cranking), or the engine 6 has already started.

The target temperature setting portion P5 acquires the cooling water temperature, the intake air temperature, the fuel injection amount (fuel injection time), the engine speed (engine revolutions), the intake pressure (pressure inside the intake manifold 51), the valve timing (opening and closing timing of each of the intake valve 63c and the exhaust valve 63d), the amount of intake air to the combustion chamber 63e, the outside air pressure (atmospheric pressure), and the filling rate (a rate of new air within the cylinder 62a). The target temperature setting portion P5 specifies the target heating temperature (for example, 110 degrees C.) of the fuel heater 13 using a target temperature setting map based on the aforementioned multiple pieces of information. The target temperature setting map is acquired beforehand. The aforementioned multiple pieces of information are included in information obtainable from the engine 6.

The target temperature control portion P6 includes a function to acquire the amount of electricity for controlling the fuel heating portion 131 to the target heating temperature.

Specifically, the target temperature control portion P6 obtains the target heating temperature from the target temperature setting portion P5. The target temperature control portion P6 acquires electricity by feedback control in accordance with the target heating temperature and the present temperature of the fuel heating portion 131. Such feedback control is performed before the start of cranking (i.e., the engine 6 has not yet started), during the cranking (the engine 6 is starting), and after the end of cranking (i.e., the engine 6 has already started).

The target temperature control portion P6 acquires electricity for restraining disturbance including the fuel that deprives heat from the fuel heating portion 131 and the intake air that deprives heat from the fuel heating portion 131 by feedforward control in accordance with the target heat temperature. The feedforward control is performed during the starting and after the starting of the engine 6. The target temperature control portion P6 acquires the cooling water temperature, the intake air temperature, the outside air temperature or the fuel temperature, the fuel injection amount (fuel injection time), the engine speed (engine revolutions), the intake pressure (pressure inside the intake manifold 51), the valve timing (opening and closing timing of each of the intake valve 63c and the exhaust valve 63d), the amount of intake air to the combustion chamber 63e, the outside air pressure (atmospheric pressure), the filling rate (a rate of new air within the cylinder 62a), the present temperature of the fuel heating portion 131, the battery charge remaining R, and the acceleration opening. The target temperature control portion P6 specifies a feedforward control constant using a map for feedforward control constant based on the aforementioned multiple pieces of information. The map is acquired beforehand. The aforementioned multiple pieces of information are included in information obtainable from the engine 6.

The electricity obtained by the target temperature control portion P6 is acquired by the heating control portion 133.

The pre-start fuel atomization determination portion P7 includes a function to determine whether to perform the fuel injection before the starting, during the starting, or after the starting of the engine 6. Specifically, the pre-start fuel atomization determination portion P7 acquires the determination result of the battery charge remaining determination portion P3 and the determination result of the engine start determination portion P4. The pre-start fuel atomization determination portion P7 determines whether to perform the fuel injection before the starting, during the starting, or after the starting of the engine 6 in accordance with the determination result of the battery charge remaining determination portion P3 and the determination result of the engine start determination portion P4.

The fuel injection control portion P8 includes a function to obtain the injection time for bringing the fuel injection amount of the injector 64 to the target injection amount. Specifically, the fuel injection control portion P8 chooses and decides an appropriate injection control from among plural injection controls based on the determination result of the pre-start fuel atomization determination portion P7 and obtains the fuel injection time using a map for fuel injection. The fuel injection control portion P8 includes, as the plural injection controls, a start-up increasing control, a warm-up increasing control, a normal injection control, a first acceleration injection control, a second acceleration injection control, a third acceleration injection control, and a feedback fuel injection control.

The start-up increasing control is a control to increase the fuel injection as time proceeds after the start of the engine 6. The warm-up increasing control is a control to increase the fuel injection relative to that obtained in the start-up increasing control after the start of the engine 6. The normal injection control is a control to decrease the fuel injection relative to that obtained in the warm-up increasing control. The first acceleration injection control is a control to increase the fuel injection relative to that obtained in the warm-up increasing control. The second acceleration injection control is a control to increase the fuel injection relative to that obtained in the normal fuel injection. The third acceleration injection control is a control to increase the fuel injection relative to that obtained in the feedback fuel injection control. The feedback fuel injection control is a control to cause the fuel injection to follow the target fuel injection amount.

The fuel injection time obtained by the fuel injection control portion P8 is acquired by the injector 64.

The heating control portion 133 is configured to obtain a duty ratio for controlling the fuel heating portion 131 in accordance with the electricity obtained by the target temperature control portion P6 before the starting, during the starting, or after the starting of the engine 6. The heating control portion 133 controls the electricity from the auxiliary battery 11 based on the acquired duty ratio.

The heating control portion 133 also obtains a resistance value in accordance with electric current flowing through the fuel heating portion 131 and voltage measured at the fuel heating portion 131. Such resistance value is associated with the temperature of the fuel heating portion 131 that vaporizes the fuel.

The heating control portion 133 is constituted by a driver including the CPU 133a that serves as a control circuit and a storage portion 133b that includes memory and serves as a storage medium. The heating control portion 133 controls the electricity supplied from the auxiliary battery 11 to the fuel heating portion 131 in a state where the CPU 133a implements power supply control program stored at the storage portion 133b.

As illustrated in FIGS. 3 and 4, the electric vehicle 100 performs a temperature control (fuel heating control) of the fuel heating portion 131 with the aforementioned functions of the engine control portion 132 and the heating control portion 133. The engine control portion 132 performs a processing to obtain the electricity supplied to the fuel heating portion 131. The heating control portion 133 performs a calculation of duty ratio supplied to the fuel heating portion 131. The engine control portion 132 performs a main processing of the fuel heating control. The fuel heating control includes a first heater temperature control, a second heater temperature control, a third heater temperature control, and a fourth heater temperature control.

The first to fourth heater temperature controls are explained as below.

The engine control portion 132 according to the first embodiment is configured to control the amount of electricity supplied from the auxiliary battery 11 to the fuel heating portion 131 based on the battery charge remaining R. Specifically, the engine control portion 132 changes control conditions of the fuel heating portion 131 based on the battery charge remaining R before the starting, during the starting, or after the starting of the engine 6.

As illustrated in FIGS. 5 to 8, the engine control portion 132 is configured to preheat the fuel heating portion 131 to a target heating temperature so that the battery charge remaining R is inhibited from decreasing to or below the first threshold value C1 before the engine start. The engine speed, the battery charge remaining R, the heater temperature and the amount of electricity in any timing charts of FIGS. 5 to 7 are examples.

In a case where the battery charge remaining R is equal to or smaller than the first threshold value C1 at the start of the engine 6 (i.e., specifically, right before the engine start), the engine control portion 132 is configured to perform the first heater temperature control (first control) for increasing the amount of electricity from the auxiliary battery 11 to the fuel heating portion 131 for a time period until the engine 6 starts (i.e., starts cranking) as illustrated in FIG. 5. That is, the engine control portion 132 increases the amount of electricity from the auxiliary battery 11 to the fuel heating portion 131 for a time period until the engine 6 starts in a case where the battery charge remaining R is estimated to be smaller than the first threshold value C1 (battery lower limit value).

Specifically, the engine control portion 132 increases the electricity to the fuel heating portion 131 from the auxiliary battery 11 for a time period until the engine 6 starts by specifying the target heating temperature of the fuel heating portion 131 to a higher temperature than a temperature employed when the battery charge remaining R exceeds the first threshold value C1, in a case where the battery charge remaining R is equal to or smaller than the first threshold value C1.

Specifically, the engine control portion 132 is configured to obtain the battery charge remaining R before the start of the engine (i.e., at a point A before a cranking start in FIG. 5). The engine control portion 132 performs a control so that the target temperature setting portion P5 specifies a second target heating temperature T2 higher than a first target heating temperature T1 that is minimally required to vaporize the fuel in a case where the obtained battery charge remaining R is greater than the first threshold value C1 and smaller than the second threshold value C2 before the start of the engine 6. The engine control portion 132 adjusts the amount of electricity supplied to the fuel heating portion 131 from the auxiliary battery 11 by feedback control in accordance with a difference between the temperature (heater temperature) of the fuel heating portion 131 and the second target heating temperature T2 before the start of the engine 6. The engine control portion 132 maintains the fuel heating portion 131 at the second target heating temperature T2 by feedback control after the temperature of the fuel heating portion 131 becomes the second target heating temperature T2 before the start of the engine 6.

The point A in FIG. 5 corresponds to a point before the driver of the vehicle starts the engine 6. Specifically, the point A is obtained by the driver approach determination portion P1 of the engine control portion 132 that determines whether the driver is close to the electric vehicle 100 in accordance with the smart key signal, the door lock signal, the seating signal, the brake pedal signal, and the engine start signal, for example.

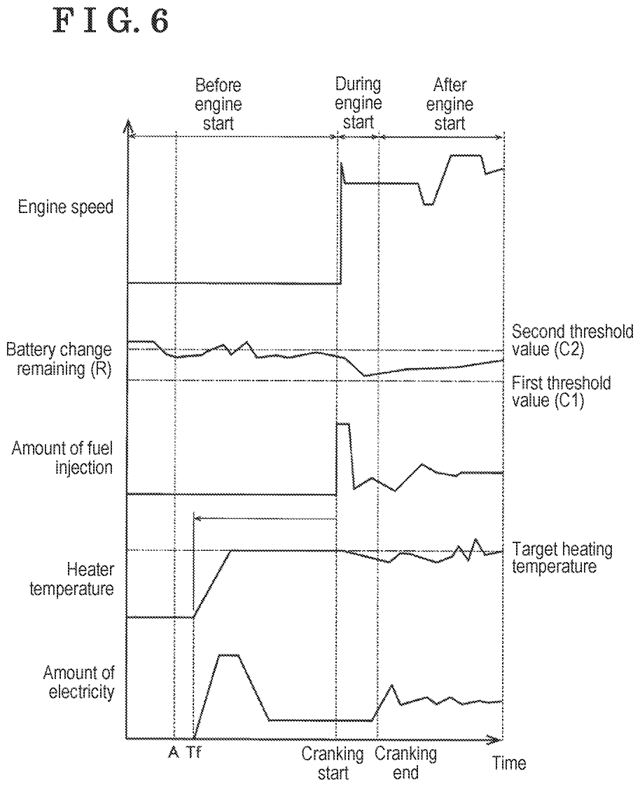

As illustrated in FIG. 6, the engine control portion 132 is also configured to perform the second heater temperature control (second control) for increasing the fuel heating time by the fuel heating portion 31 for a time period until the engine 6 starts in a case where the battery charge remaining R is estimated to be equal to or smaller than the first threshold value C1 at the start of the engine 6 (right before the engine start).

Specifically, in a case where the battery charge remaining R is equal to or smaller than the first threshold value C1, the engine control portion 132 specifies power supply time to the fuel heating portion 131 from the auxiliary battery 11 to be longer than time employed when the battery charge remaining R exceeds the threshold value C1. The engine control portion 132 thus increases the electricity to the fuel heating portion 131.

The engine control portion 132 is configured to obtain the battery charge remaining R before the engine start (at the point A before the cranking start in FIG. 6). The engine control portion 132 performs a control so that the target temperature control portion P6 specifies a predetermined timing Tf for achieving the target heating temperature to be earlier than normal timing in a case where the obtained battery charge remaining R is greater than the first threshold value C1 and smaller than the second threshold value C2 before the start of the engine 6. The engine control portion 132 performs a feedback control based on the temperature of the fuel heating portion 131 (heater temperature) and the target heating temperature at the predetermined timing Tf before the start of the engine 6. The engine control portion 132 thus adjusts the amount of electricity supplied to the fuel heating portion 131 from the auxiliary battery 11. The fuel heating portion 131 stores heat to restrain the temperature during the engine start (cranking) from decreasing. The engine control portion 132 is configured to maintain the temperature of the fuel heating portion 131 at the target heating temperature by feedback control after the temperature of the fuel heating portion 131 reaches the target heating temperature before the start of the engine 6. The aforementioned normal timing corresponds to timing for achieving the target heating temperature of the fuel heating portion 131 during the first heater temperature control.

The engine control portion 132 is configured to start heating the fuel by the fuel heating portion 131 and to increase the amount of electricity from the auxiliary battery 11 to the fuel heating portion 131 based on the predetermined timing Tf before a vehicle driver performs an operation to start the engine 6.

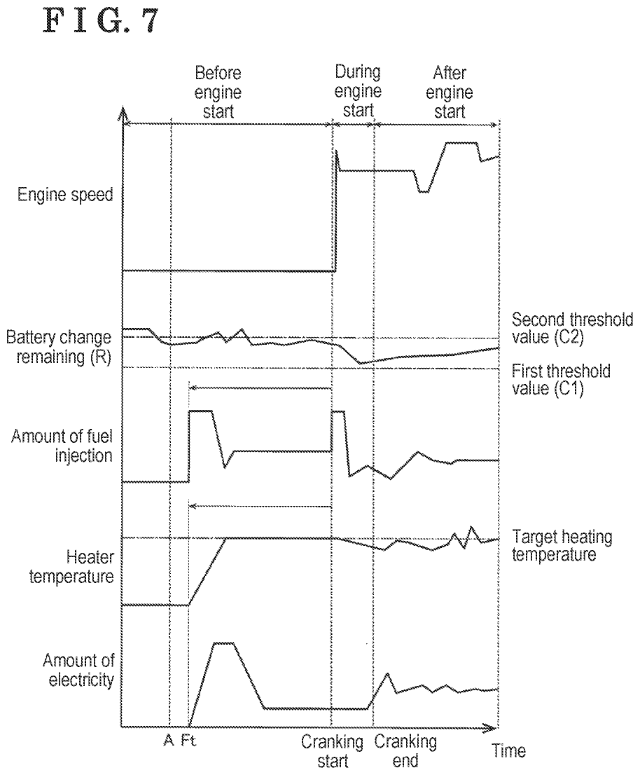

As illustrated in FIG. 7, in a case where the battery charge remaining R is estimated to be equal to or smaller than the first threshold value C1 at the start of the engine 6 (right before the engine start), the engine control portion 132 is configured to perform the third heater temperature control where the fuel injection timing Ft of the injector 64 is set earlier than the cranking start and the fuel heating time of the fuel heating portion 131 increases.

Specifically, in a case where the battery charge remaining R is equal to or smaller than the first threshold value C1, the engine control portion 132 increases the fuel heating time of the fuel heating portion 131 by specifying timing for supplying the fuel earlier than timing employed when the battery charge remaining R exceeds the first threshold value C1.

The engine control portion 132 is configured to obtain the battery charge remaining R before the start of the engine 6 (at the point A before the cranking start in FIG. 7). In a case where the obtained battery charge remaining R is greater than the first threshold value C1 and smaller than the second threshold value C2, the engine control portion 132 performs a control so that the fuel injection control portion P8 specifies the fuel injection timing Ft of the injector 64 to be earlier than the cranking start. Additionally, the engine control portion 132 performs a target temperature control to specify timing for achieving the target heating temperature to be earlier than the cranking start by conforming to the fuel injection timing Ft. The engine control portion 132 adjusts the amount of electricity from the auxiliary battery 11 to the fuel heating portion 131 by feedback control based on a difference between the temperature of the fuel heating portion 131 (heater temperature) and the target heating temperature at the fuel injection timing Ft before the start of the engine 6. Time during which the fuel stays at the fuel heating portion 131 increases, which increases vaporization time of the fuel at the fuel heating portion 131. After the temperature of the fuel heating portion 131 reaches the target heating temperature before the engine start, the engine control portion 132 maintains the temperature of the fuel heating portion 131 at the target heating temperature by feedback control.

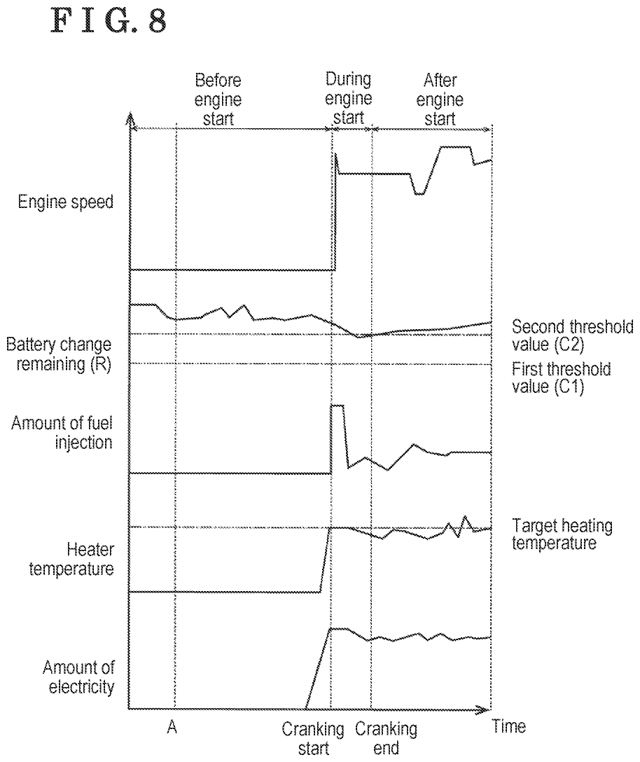

As illustrated in FIG. 8, in a case where the battery charge remaining R exceeds the first threshold value C1 at the start of the engine 6 (right before the engine start), the engine control portion 132 is configured to perform the fourth heater temperature control for adjusting the electricity supplied from the auxiliary battery 11 to the fuel heating portion 131 by feedback control based on the temperature of the fuel heating portion 131 and the target heating temperature for a time period before the starting and during the starting (cranking) of the engine 6. Specifically, the engine control portion 132 continuously adjusts the electricity from the auxiliary battery 11 to the fuel heating portion 131 during the cranking in a case where the battery charge remaining R is estimated to exceed the first threshold value C1.

The engine control portion 132 constantly measures and monitors the battery charge remaining R after the power supply to the fuel heating portion 131 is started and again determines or chooses one of the first to fourth heater heating controls based on sufficiency of the battery charge remaining R.

In a case where power consumption of the auxiliary battery 11 caused by an electric component other than the fuel heating portion 131 continues for a predetermined time or more before the start of the engine 6, the engine control portion 132 decreases the electricity supplied from the auxiliary battery 11 to the fuel heating portion 131 or stops the supply based on the fact that the fuel heating portion 131 reaches the target heating temperature. The engine control portion 132 also restarts supply of electricity from the auxiliary battery 11 to the fuel heating portion 131 based on the start of the engine 6.

In a case where the driver's operation relates to or belongs to the operation before the starting of the engine 6, and the electricity from the auxiliary battery 11 to an accessory and an electric component continues for a predetermined time or more, the engine control portion 132 decreases the electricity to the fuel heating portion 131 (decreases a duty ratio) or stops heating by the fuel heating portion 131, without performing the feedback control, based on the fact that the fuel heating portion 131 reaches the target heating temperature. The engine control portion 132 reheats the fuel heating portion 131 when the driver starts the engine 6 (i.e., cranking is started).

The fuel heating portion 131 is not necessary to be rapidly heated to the target heating temperature when the electric vehicle 100 is driven with the driving motor 1. The fuel heating portion 131 is desirably heated with smaller duty ratio (for example, 50%) than maximum duty ratio (for example, 100%). The power consumption of the auxiliary battery 11 is reduced accordingly.

As illustrated in FIGS. 5 to 8, the engine control portion 132 is configured to heat the fuel heating portion 131 so that the battery charge remaining R is inhibited from falling to or below the first threshold value C1 and the heater temperature maintains the target heating temperature. The engine speed (engine revolutions), the battery charge remaining R, the fuel injection amount, the heater temperature, and the amount of electricity in any timing charts of FIGS. 5 to 8 are examples.

An example where the battery charge remaining R is greater than the first threshold value C1 during the engine start (i.e., cranking) is explained with the fourth heater temperature control illustrated in FIG. 8.

As illustrated in FIG. 8, the target temperature control portion P6 of the engine control portion 132 maintains the heater temperature at the target heating temperature by feedback control and acquires additional electricity for restraining disturbance by feedforward control. The engine control portion 132 is configured to adjust the battery charge remaining R so that the battery charge remaining R is inhibited from falling below the first threshold value C1 .

Specifically, in a case where the battery charge remaining R exceeds the first threshold value C1 during the engine start, the engine control portion 132 obtains a control constant of feedforward control based on information obtainable from the engine 6. Such feedforward control restrains temperature decrease (disturbance) of the fuel heating portion 131 caused by fuel adhesion to the fuel heating portion 131, by increasing the electricity to the fuel heating portion 131. The engine control portion 132 supplies the electricity to the fuel heating portion 131 to maintain the fuel heating portion 131 at the target heating temperature by feedback control while increasing the electricity to the fuel heating portion 131 by feedforward control with the control constant.

Specifically, the target temperature control portion P6 of the engine control portion 132 estimates decrease of the heater temperature of the fuel heating portion 131 using a map for heater temperature decrease based on the cooling water temperature, the intake air temperature, the outside temperature or the fuel temperature, the fuel injection amount (fuel injection time), the engine speed (revolutions), the intake pressure (pressure inside the intake manifold 51), the valve timing (opening and closing timing of each of the intake valve 63c and the exhaust valve 63d), the amount of intake air to the combustion chamber 63e, the outside pressure (atmospheric pressure), the filling rate (a rate of new air within the cylinder 62a), the current temperature of the fuel heating portion 131, the battery charge remaining R, and the acceleration opening.

The target temperature control portion P6 of the engine control portion 132 obtains a feedforward control constant using the feedforward control constant map based on the heater temperature decrease. The engine control portion 132 maintains the fuel heating portion 131 at the target heating temperature by the feedback control while increasing the electricity to the fuel heating portion 131 by the feedforward control based on the obtained feedforward control constant.

The engine control portion 132 further increases the electricity to the fuel heating portion 131 when the heater temperature decreases even by performing both the feedforward control and the feedback control. Specifically, in a case where the duty ratio obtained by the heating control portion 133 is smaller than the maximum duty ratio, the electricity to the fuel heating portion 131 increases by an amount corresponding to a difference between the obtained duty ratio and the maximum duty ratio. In a case where the duty ratio obtained by the heating control portion 133 is substantially the same as the maximum duty ratio, the target heating temperature is raised to increase the electricity to the fuel heating portion 131.

The electric vehicle 100 mainly starts with motoring. This causes large temperature decrease of the fuel heating portion 131 resulting from air flowing through the exhaust port 63a from the intake port 63b. It is thus desirable that a processing for increasing the electricity to the fuel heating portion 131 is performed at the electric vehicle 100.

The engine control portion 132 keeps updating the feedforward control constant during the engine start (cranking) and performs the feedback control based on the measured heater temperature and the target heating temperature.

Next, an example where the battery charge remaining R is equal to or smaller than the first threshold value C1 during the engine start is explained with the third heater temperature control illustrated in FIG. 7.

When the battery charge remaining R becomes (or is estimated to be) equal to or smaller than the first threshold value C1 during the engine start, the engine control portion 132 supplies the electricity to the fuel heating portion 131 so as to maintain the fuel heating portion 131 at the target heating temperature by the feedback control, without performing the feedforward control as illustrated in FIG. 7. Specifically, the target temperature control portion P6 of the engine control portion 132 maintains the heater temperature at the target heating temperature by only the feedback control in a case where the battery charge remaining R is equal to or smaller than the first threshold value C1.

In addition to the aforementioned control, the following control is also performed during the first to fourth heater temperature controls.

The engine control portion 132 decreases fuel supply at restart of the engine 6 and decreases the electricity supplied from the auxiliary battery 11 to the fuel heating portion 131 in response to the decrease of fuel supply in a case where the start of the engine 6 by the starter motor 212 fails during the engine start.

Specifically, the engine control portion 132 determines the cylinder 32a that is before the exhaust process or after the exhaust process based on the rotation angle position of the camshaft 65 and the rotation angle position of the crankshaft 66. Because scavenging of the cylinder 62a is not performed before the exhaust process, the engine control portion 132 determines that the fuel injected immediately before that point (i.e., a point where the determination is made) remains within the cylinder 62a when the cylinder 62a is in a state before the exhaust process. The engine control portion 132 thus decreases fuel injection from the injector 64 by an amount corresponding to the fuel injected immediately before that point. Additionally, because scavenging of the cylinder 62a is performed after the exhaust process, the engine control portion 132 determines that the fuel does not remain within the cylinder 62a when the cylinder 62a is in a state after the exhaust process. The engine control portion 132 is thus inhibited from decreasing fuel injection from the injector 64 by an amount corresponding to the fuel injected immediately before that point.

As illustrated in FIGS. 5 to 8, the engine control portion 132 is configured to heat the fuel heating portion 131 so that the heater temperature is maintained at the target heating temperature in a state where the battery charge remaining R is sufficient relative to the first threshold value C1, because the battery charge remaining R increases by driving of the engine 6 after the start thereof. The engine speed, the battery charge remaining R, the fuel injection amount, the heater temperature, and the amount of electricity in any timing charts of FIGS. 5 to 8 are examples.

An operation after the engine start is explained with the fourth heater temperature control illustrated in FIG. 8 as an example.

Based on information obtainable from the engine 6 after the engine start, the engine control portion 132 at least obtains a control constant of feedforward control for restraining temperature decrease of the fuel heating portion 131 caused by adhesion of the fuel thereto, by increasing the electricity to the fuel heating portion 131. The engine control portion 132 supplies the electricity to the fuel heating portion 131 so as to maintain the fuel heating portion 131 at the target heating temperature by the feedback control while increasing the electricity to the fuel heating portion 131 by the feedforward control with the control constant.

Specifically, the engine control portion 132 continues updating the feedforward control constant and performs the feedback control based on the measured heater temperature and the target heating temperature after the engine start.

The engine control portion 132 determines timing at which heating of the fuel by the fuel heating portion 131 stops, on a basis of information obtainable from the engine 6 after the engine start. The engine control portion 132 determines the aforementioned timing based on the exhaust air temperature, the catalyst temperature, the cooling water temperature, the air-fuel ratio, and the intake air temperature, for example. The aforementioned timing is desirably set after the three-way catalyst 8 is activated so that exhaust purification thereby is available.

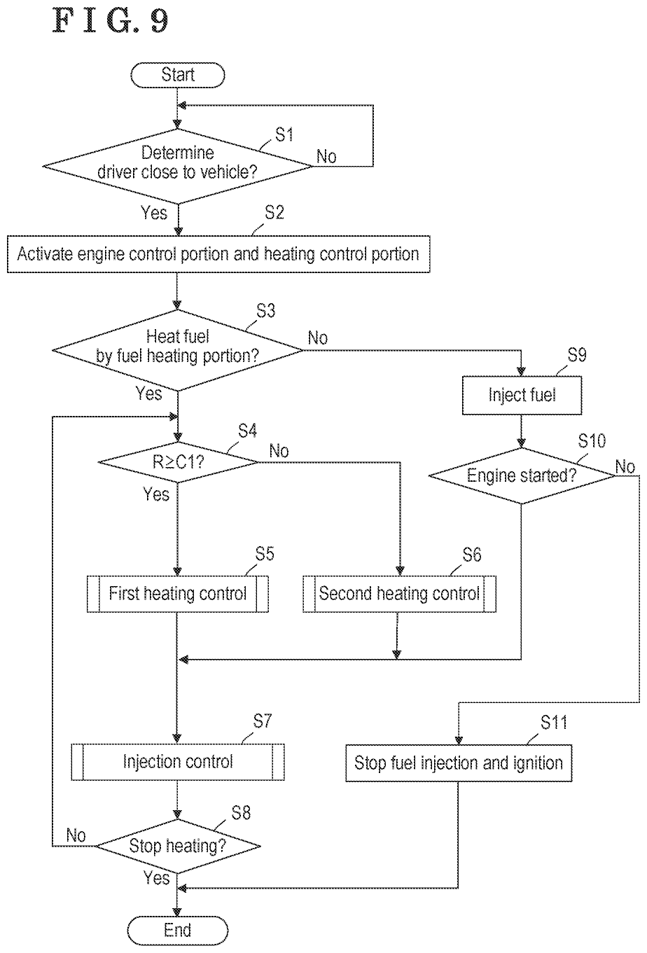

A fuel heating control processing performed by the engine control portion 132 and the heating control portion 133 is explained with reference to FIG. 9. The fuel heating control processing achieves appropriate adjustment of electricity supplied to the fuel heating portion 131 based on the battery charge remaining R.

The driver approach determination portion P1 of the engine control portion 132 determines whether a driver of the electric vehicle 100 is close to the vehicle 100 at step S1. In a case where the driver is close to the vehicle 100, the engine control portion 132 and the heating control portion 133 are activated at step S2. When the driver is not close to the vehicle 100, the operation of step S1 is repeated.

The heater control request determination portion P2 of the engine control portion 132 determines whether to heat the fuel by the fuel heating portion 131 at step S3. Specifically, the heater control request determination portion P2 determines whether to heat the fuel based on the cooling water temperature, the intake air temperature, the outside air temperature or the fuel temperature, the catalyst temperature, the engine stop time, the idling stop state, the catalyst activation state, and the ethanol concentration. When it is decided to heat the fuel by the fuel heating portion 131, the operation proceeds to step S4. When it is decided not to heat the fuel by the fuel heating portion 131, the operation proceeds to step S9.

At step S4, the engine control portion 132 determines whether the battery charge remaining R is equal to or greater than the first threshold value C1. Specifically, the engine start determination portion P4 of the engine control portion 132 determines whether the engine 6 has not yet started (before the start of cranking, before starting), the engine 6 is starting (cranking), or the engine 6 has already started (after the end of cranking, after the starting) based on the engine speed (engine revolutions). The engine control portion 132 acquires the battery charge remaining R at step S4. When the battery charge remaining R is equal to or greater than the first threshold value C1, the operation proceeds to step S5 for performing a first heating control. When the battery charge remaining R is smaller than the first threshold value C1, the operation proceeds to step S6 for performing a second heating control.

The engine control portion 132 performs the injection control using the fuel injection map, based on the determination result of the pre-start fuel atomization determination portion P7 at step S7. In the injection control, the engine control portion 132 controls the fuel to be injected from the injector 64 based on the fuel injection time.

The engine control portion 132 then determines whether to stop heating the fuel heating portion 131 at step S8. In case of stopping the heating, the fuel heating control processing is terminated. In case of continuing the heating, the operation returns to step S4.

The engine control portion 132 performs the injection control using the fuel injection map based on the determination result of the pre-start fuel atomization determination portion P7 at step S9. In the injection control, the engine control portion 132 controls the fuel to be injected from the injector 64 based on the fuel injection time.

The engine control portion 132 determines whether the engine 6 has started at step S10. In a case that the engine 6 has started, the operation proceeds to step S7. When the engine 6 has not started, the operation proceeds to step S11 where the fuel injection and ignition are stopped and thereafter the fuel heating control processing is terminated.

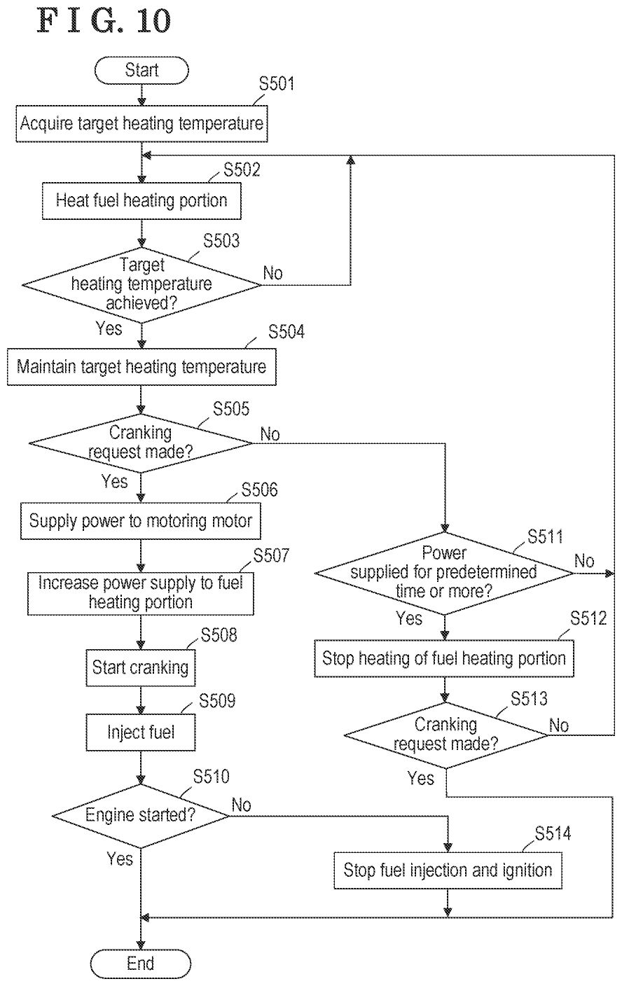

A first heating control processing performed by the engine control portion 132 and the heating control portion 133 is explained with reference to FIG. 10. The first heating control processing achieves appropriate adjustment of electricity supplied to the fuel heating portion 131 in a state where the battery charge remaining R is relatively sufficient.

The engine control portion 132 acquires the target heating temperature at step S501. Specifically, the target temperature setting portion P5 of the engine control portion 132 specifies the target heating temperature of the fuel heater 13 using the target temperature setting map based on the determination result of the heater control request determination portion P2, the determination result of the battery charge remaining determination portion P3, the determination result of the engine start determination portion P4, the cooling water temperature, the intake air temperature, the fuel injection amount (time), the engine speed (revolutions), the intake pressure (the pressure inside the intake manifold 51), the valve timing (the opening and closing timing of each of the intake valve 63c and the exhaust valve 63d), the amount of intake air to the combustion chamber 63e, the outside pressure (atmospheric pressure), and the filling rate (rate of new air within the cylinder 62a).

The fuel heating portion 131 is heated by the feedback control based on the current temperature of the fuel heating portion 131 and the target heating temperature at step S502. It is determined whether the temperature of the fuel heating portion 131 achieves the target heating temperature at step S503. When the temperature of the fuel heating portion 131 achieves the target heating temperature, the operation proceeds to step S504 so that the target heating temperature is maintained by the feedback control. When the temperature of the fuel heating portion 131 does not achieve the target heating temperature, the operation returns to step S502.

It is determined whether the engine control portion 132 receives a cranking request at step S505. In a case where the engine control portion 132 receives the cranking request, the operation proceeds to step S506. In a case where the engine control portion 132 does not receive the cranking request, the operation proceeds to step S511.

The motoring motor 12 is powered at step S506. The electricity to the fuel heating portion 131 increases at step S507. Specifically, the target temperature control portion P6 of the engine control portion 132 acquires the electricity by the feedback control based on a difference between the target heating temperature and the current temperature of the fuel heating portion 131. The target temperature control portion P6 of the engine control portion 132 further obtains the electricity by the feedforward control based on the target heating temperature and the feedforward control constant. The engine cranking is started at step S508.

The engine control portion 132 performs fuel injection using the fuel injection map, based on the determination result of the pre-start fuel atomization determination portion P7 at step S509. At this time, the engine control portion 132 controls the fuel to be injected from the injector 64 in accordance with the fuel injection time.

The engine control portion 132 determines whether the engine 6 has started at step S510. In a case that the engine 6 has started, the first heating control processing is terminated and the operation proceeds to step S7. When the engine 6 has not started, the operation proceeds to step S514 where the fuel injection and ignition are stopped and thereafter the first heating control processing is terminated.

The engine control portion 132 determines whether the fuel heating portion 131 is powered for a predetermined time or more at step S511. When the fuel heating portion 131 is powered for the predetermined time or more, the operation proceeds to step S512. When the fuel heating portion 131 is not heated for the predetermined time or more, the operation returns to step S502. It is determined whether the engine control portion 132 receives the cranking request at step S513. In a case where the engine control portion 132 receives the cranking request, the first heating control processing is terminated and the operation proceeds to step S7. In a case where the engine control portion 132 does not receive the cranking request, the operation returns to step S502.

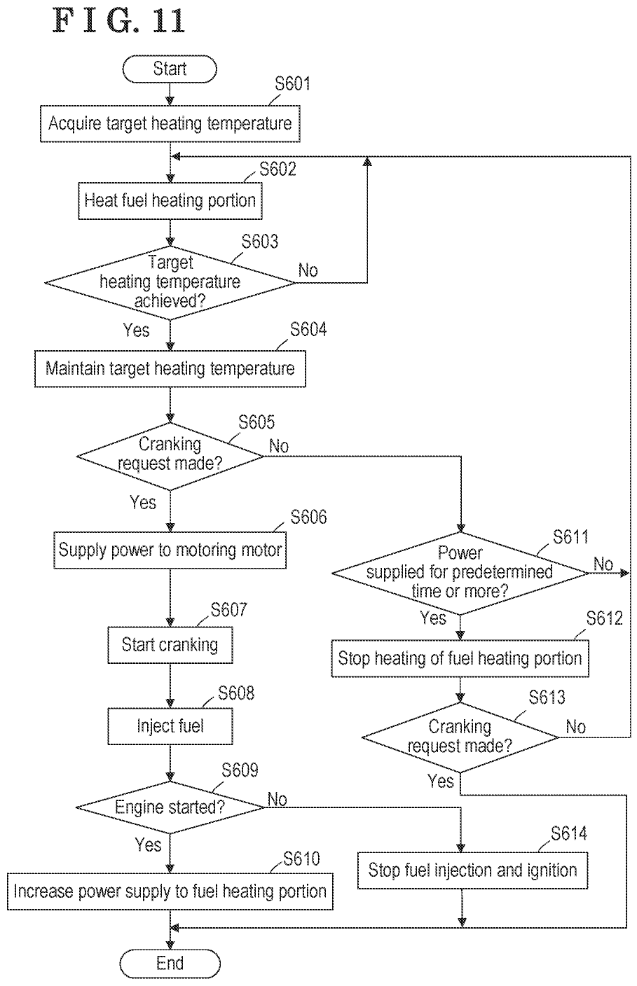

A second heating control processing performed by the engine control portion 132 and the heating control portion 133 is explained with reference to FIG. 11. The second heating control processing achieves appropriate adjustment of electricity supplied to the fuel heating portion 131 in a state where the battery charge remaining R is not sufficient.

In the second heating control processing, steps S601 to S606 are substantially the same as steps S501 to S506 of the first heating control processing. Additionally, steps S607 to S614 of the second heating control processing are substantially the same as steps S508 to S510, S507, S511 to S514 of the first heating control processing. Upon termination of the second heating control processing, the operation proceeds to step S7 of the fuel heating control processing.

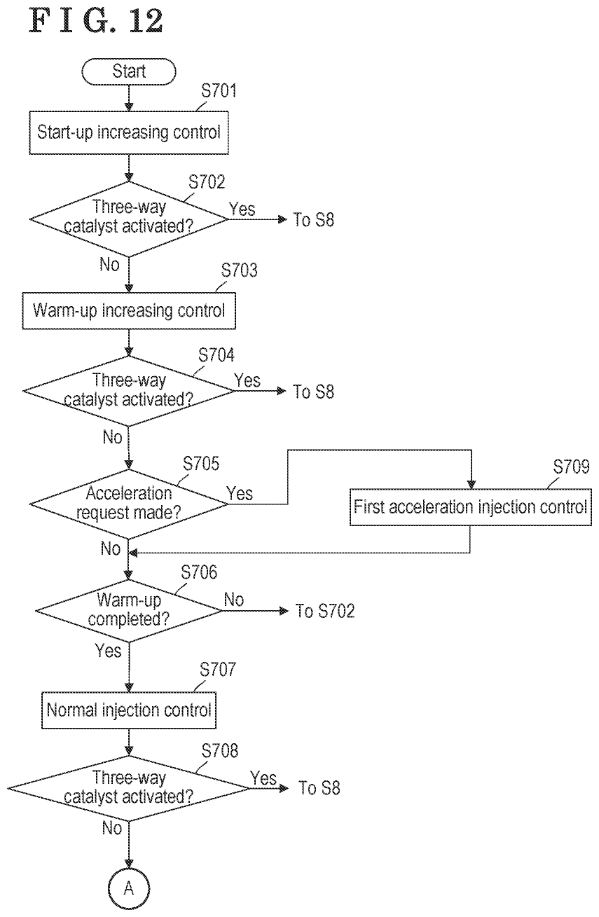

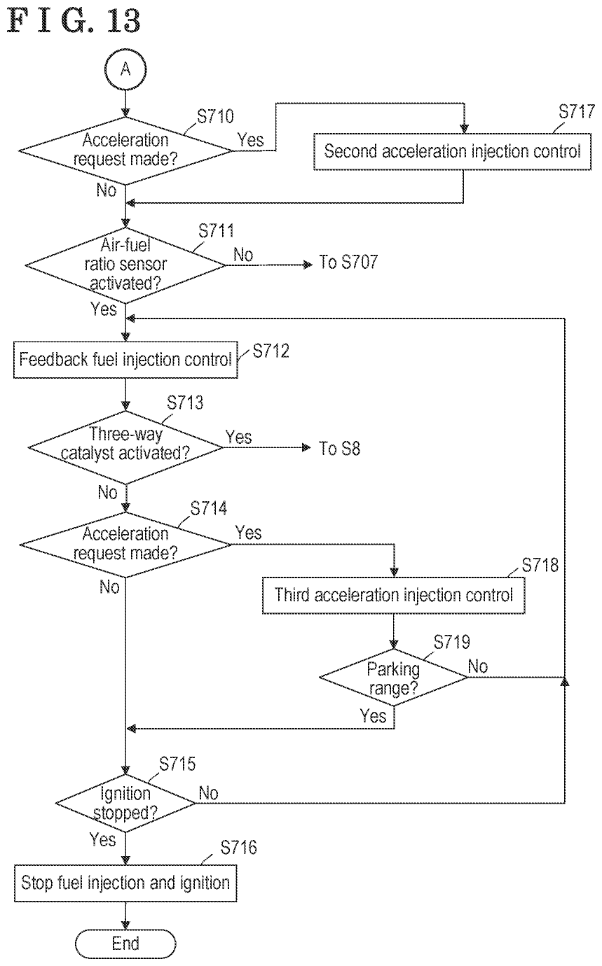

An injection control processing performed by the engine control portion 132 and the heating control portion 133 is explained with reference to FIGS. 12 and 13. The injection control processing is provided for injecting the fuel by the injector 64 while the fuel heating portion 131 is being heated.

The engine control portion 132 performs the start-up increasing control using the fuel injection map that is acquired in accordance with the determination result of the pre-start fuel atomization determination portion P7 at step S701. The engine control portion 132 then determines whether the three-way catalyst is activated at step S702. In a case where the three-way catalyst is activated, the operation proceeds to step S8. In a case where the three-way catalyst is not activated, the operation proceeds to step S703. The engine control portion 132 performs the warm-up increasing control using the fuel injection map that is acquired in accordance with the determination result of the pre-start fuel atomization determination portion P7 at step S703.

The engine control portion 132 determines whether the three-way catalyst is activated at step S704. In a case where the three-way catalyst is activated, the operation proceeds to step S8. In a case where the three-way catalyst is not activated, the operation proceeds to step S705. At step S705, it is determined whether the engine control portion 132 receives an acceleration request. In a case where the engine control portion 132 receives the acceleration request, the operation proceeds to step S709 to perform the first acceleration injection control where the fuel injection amount further increases than that of the warm-up increasing control. In a case where the engine control portion 132 does not receive the acceleration request, the operation proceeds to step S706.

The engine control portion 132 determines whether the warm-up operation is completed at step S706. When the engine control portion 132 determines that the warm-up operation is completed, the operation proceeds to step S707. When the engine control portion 132 determines that the warm-up operation is not completed, the operation returns to step S702.

At step S707, the engine control portion 132 performs the normal injection control using the fuel injection map that is acquired in accordance with the determination result of the pre-start fuel atomization determination portion P7. The engine control portion 132 determines whether the three-way catalyst is activated at step S708. In a case where the three-way catalyst is activated, the operation proceeds to step S8. In a case where the three-way catalyst is not activated, the operation proceeds to step S710. At step S710, it is determined whether the engine control portion 132 receives the acceleration request. When the engine control portion 132 receives the acceleration request, the operation proceeds to step S717 to perform the second acceleration injection control where the fuel injection amount further increases than that of the normal injection control. When the engine control portion 132 does not receive the acceleration request, the operation proceeds to step S711.

The engine control portion 132 determines whether the air-fuel sensor is activated at step S711. In a case where the air-fuel sensor is activated, the operation proceeds to step S712. In a case where the air-fuel sensor is not activated, the operation returns to step S707.

At step S712, the engine control portion 132 performs the feedback fuel injection control of the fuel injected by the injector 64 using the fuel injection map that is acquired in accordance with the determination result of the pre-start fuel atomization determination portion P7. The engine control portion 132 determines whether the three-way catalyst is activated at step S713. In a case where the three-way catalyst is activated, the operation proceeds to step S8. In a case where the three-way catalyst is not activated, the operation proceeds to step S714. At step S714, it is determined whether the engine control portion 132 receives the acceleration request. When the engine control portion 132 receives the acceleration request, the operation proceeds to step S718 to perform the third acceleration injection control where the fuel injection amount further increases than that of the feedback fuel injection control. When the engine control portion 132 does not receive the acceleration request, the operation proceeds to step S715.

The engine control portion 132 determines whether the gear is in the parking range at step S719. When the gear is determined to be in the parking range, the operation proceeds to step S715. When the gear is not determined to be in the parking range, the operation returns to step S712.

At step S715, the engine control portion 132 determines whether the ignition is stopped. When the engine control portion 132 determines that the ignition is stopped, the operation proceeds to step S716 to terminate the injection control processing after the fuel injection and ignition are stopped. The operation then proceeds to step S8. When the engine control portion 132 does not determine that the ignition is stopped, the operation returns to step S712.

According to the first embodiment, the fuel heater 13 includes the engine control portion 132 that increases the amount of electricity supplied from the auxiliary battery 11 to the fuel heating portion 131 or increases fuel heating time by the fuel heating portion 131 for a time period until the engine 6 starts in a case where the battery charge remaining R is equal to or smaller than the first threshold value C1 at the start of the engine 6 (right before the start of the engine 6). The fuel heating portion 131 thus stores heat beforehand up to start of the engine 6 for the amount corresponding to the increase of electricity to the fuel heating portion 131 even when the battery charge remaining R is equal to or smaller than the first threshold value C1. The temperature of the fuel heating portion 131 is inhibited from excessively decreasing at the start of the engine 6 by the motoring motor 12. Additionally, the fuel heating portion 131 stores heat beforehand up to start of the engine 6 for the amount corresponding to the increase of fuel heating time, by increasing the fuel heating time of the fuel heating portion 131, even when the battery charge remaining R is equal to or smaller than the first threshold value C1. The temperature of the fuel heating portion 131 is inhibited from excessively decreasing at the start of the engine 6 by the motoring motor 12 accordingly. In a case where the battery charge remaining R is equal to or smaller than the first threshold value C1 at the start of the engine 6, the fuel heating portion 131 sufficiently vaporizes the fuel at the start of the engine 6 by the motoring motor 12.

The first threshold value C1 is a battery lower limit serving as a lower limit of electricity for operating the fuel heating portion 131 and the engine 6. In a case where the battery charge remaining R falls below the battery lower limit, the engine control portion 132 increases the electricity from the auxiliary battery 11 to the fuel heating portion 131 for a time period until the engine 6 starts. The fuel heating portion 131 stores heat for a time period until the engine 6 starts, so that electricity corresponding to the stored heat is not necessary to be supplied to the fuel heating portion 131. The supply of electricity to the fuel heating portion 131 may decrease at the time of engine start 6 by the motoring motor 12. The aforementioned decrease of electricity to the fuel heating portion 131 may secure the electricity necessary for operating the engine 6, which achieves the secure start of the engine 6.

In a case where the battery charge remaining R at the engine start (right before the engine start) is equal to or smaller than the first threshold value C1, the engine control portion 132 increases the amount of electricity to the fuel heating portion 131 for a time period until the engine 6 starts by specifying the target heating temperature of the fuel heating portion 131 to be higher than the temperature employed in a case where the battery charge remaining R exceeds the first threshold value C1. The engine control portion 132 is thus configured to increase the electricity to the fuel heating portion 131. The electricity supplied to the fuel heating portion 131 increases in conjunction with the target heating temperature that is re-specified. The fuel heating portion 131 thus securely and adequately stores heat beforehand for a time period until the engine 6 starts.

Additionally, in a case where the battery charge remaining R at the engine start is equal to or smaller than the first threshold value C1, the engine control portion 132 increases the amount of electricity to the fuel heating portion 131 for a time period until the engine 6 starts by specifying time of supplying the electricity to the fuel heating portion 131 from the auxiliary battery 11 to be longer than the time employed when the battery charge remaining R is greater than the first threshold value C1. The engine control portion 132 is thus configured to increase the electricity to the fuel heating portion 131. The engine 6 is able to start in a state where the fuel heating portion 131 securely stores heat, being different from a case where the electricity supplied from the auxiliary battery 11 to the fuel heating portion 131 rapidly increases. The temperature of the fuel heating portion 131 is securely inhibited from decreasing while the engine 6 is starting by the motoring motor 12.

Further, in a case where the battery charge remaining R at the engine start is equal to or smaller than the first threshold value C1, the engine control portion 132 specifies timing of fuel supply to be earlier than the timing employed when the battery charge remaining R is greater than the first threshold value C1. The engine control portion 132 is thus configured to increase the fuel heating time of the fuel heating portion 131. The fuel heating time of the fuel heating portion 131 is sufficiently secured, which achieves secure vaporization of fuel performed by the fuel heating portion 131. Possibility of accidental fire at the start of the engine 6 is restrained accordingly.

In case of start-up failure of the engine 6 by the motoring motor 12, the engine control portion 132 decreases the fuel supply amount and decreases the electricity from the auxiliary battery 11 to the fuel heating portion 131 in accordance with the aforementioned decrease of fuel supply at restart of the engine 6. This restrains the fuel supply from being excessive and reduces waste of electricity at the restart of the engine 6. Possibility of accidental fire caused by excessive fuel supply at the restart of the engine 6 is restrained and waste of electricity of the auxiliary battery 11 is reduced accordingly.

In the first embodiment, the fuel heater 13 includes the intake apparatus 5 that supplies air to the combustion chamber 63e within the cylinder 62a. The intake apparatus 5 includes the port portion 52 into which the fuel injected from the injection port of the injector 64 is introduced and the intake passage 53 provided inside the port portion 52 and flowing the air-fuel mixture supplied to the cylinder 62a. The fuel heating portion 131 includes the port heater 131a provided along the inner surface of the port portion 52 to vaporize the fuel introduced into the intake passage 53. The intake apparatus 5 that inhibits excessive temperature decrease of the port heater 131a during the engine start by the motoring motor 12 is obtainable.

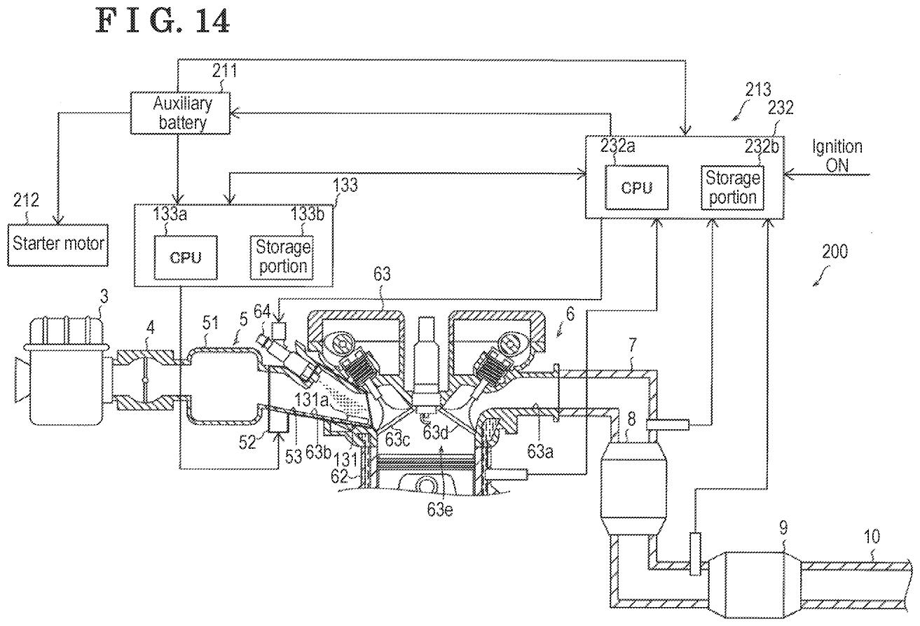

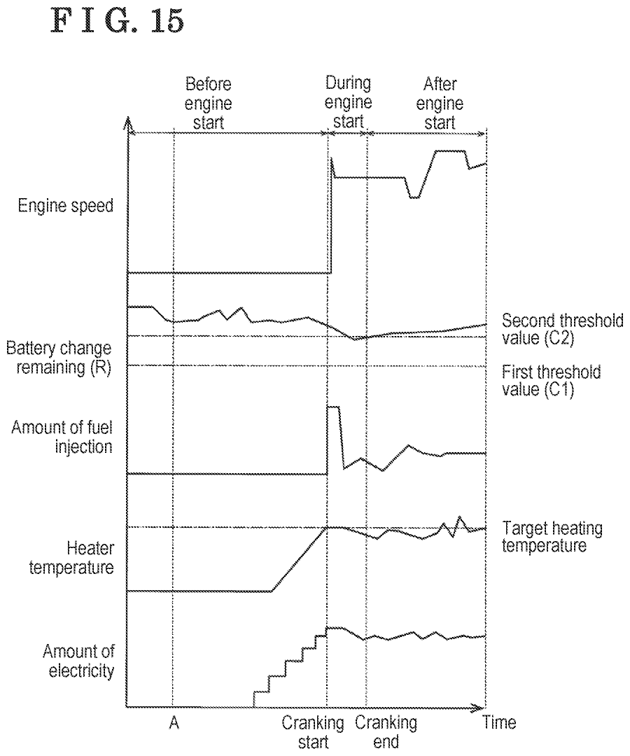

A fuel heater 213 according to the second embodiment is explained with reference to FIGS. 14 and 15. Being different from the fuel heater 13 mounted at the electric vehicle 100 such as a hybrid vehicle, for example, according to the first embodiment, the fuel heater 213 of the second embodiment is mounted at a conventional vehicle 200 such as a gasoline vehicle, for example, i.e., not a hybrid vehicle. The similar components according to the second embodiments to those of the first embodiment bear the same reference numerals and explanations thereof are omitted.

As illustrated in FIG. 14, the fuel heater 213 is mounted at the conventional vehicle 200 serving as an example of the vehicle. The conventional vehicle 200 is configured to be driven by driving the engine 6. The conventional vehicle 200 includes the air cleaner 3, the throttle 4, the intake apparatus 5, the engine 6, the exhaust pipe 7, the three-way catalyst 8, the filter 9, and the tail pipe 10.

The conventional vehicle 200 also includes a battery 211, a starter motor 212 serving as an example of the motor, and the fuel heater 213.

The fuel heater 213 is configured to heat fuel with electricity supplied from the battery 211. The fuel heater 213 preheats the fuel supplied to the engine 6. Specifically, the fuel heater 213 includes the fuel heating portion 131, an engine control portion 232 serving as an example of the controller, and the heating control portion 133 serving as an example of the controller.

The engine control portion 232 is configured to control driving of the engine 6. The engine control portion 232 is constituted by an electronic control unit (ECU) including a central processing unit (CPU) 232a and a storage portion 232b including memory as storage medium. The engine control portion 232 controls each part of the engine 6 by the CPU 232a implementing engine control program stored at the storage portion 232b.

As illustrated in FIG. 15, the target temperature control portion P6 of the engine control portion 232 acquires electricity by feedback control based on a difference between the target heating temperature and the present temperature of the fuel heating portion 131 before the engine start.

Specifically, the engine control portion 232 is configured to increase the amount of electricity supplied to the fuel heating portion 131 by gradually increasing the electricity to the fuel heating portion 131 supplied from the battery 211 for a time period until the engine 6 starts in a case where the battery charge remaining R is estimated to be equal to or smaller than the first threshold value C1. The engine control portion 232 gradually increases the electricity so as to avoid excess electric current relative to the target heating temperature, while measuring a temperature increase speed (resistance value change) of the fuel heating portion 131. The other construction of the second embodiment is similar to the first embodiment.

According to the second embodiment, the fuel heater 213 includes the engine control portion 232 that increases the amount of electricity supplied from the battery 211 to the fuel heating portion 131 or increases the fuel heating time of the heating control portion 133 in a case where the battery charge remaining R falls to or below the first threshold value C1 at the start of the engine 6. The fuel heating portion 131 thus sufficiently vaporizes the fuel at the start of the engine 6 by the starter motor 212 in a case where the battery charge remaining R is equal to or smaller than the first threshold value C1.

The engine control portion 232 increases the amount of electricity to the fuel heating portion 131 by gradually increasing the electricity from the battery 211 to the fuel heating portion 131 for a time period until the engine 6 starts than the amount of electricity employed when the battery charge remaining R is greater than the first threshold value C1, in a case where the battery charge remaining R is estimated to be equal to or smaller than the first threshold value C1 at the start of the engine 6. The temperature of the fuel heating portion 131 gradually increases in response to time delay between supply of electric current to the fuel heating portion 131 and the change of temperature thereof. The temperature of the fuel heating portion 131 may thus accurately match the target heating temperature, which leads to reduction of waste of electricity supplied to the fuel heating portion 131 from the battery 211. The other advantages of the second embodiment are similar to the first embodiment.

The aforementioned embodiments may be appropriately changed or modified as follows, for example.

According to the first and second embodiments, the engine control portion 132, 232 including the driver approach determination portion P1, the heater control request determination portion P2, the battery charge remaining determination portion P3, the engine start determination portion P4, the target temperature setting portion P5, the target temperature control portion P6, the pre-start fuel atomization determination portion P7, and the fuel injection control portion P8 is provided separately from the heating control portion 133. Alternatively, the heating control portion 133 may include all the functions of the engine control portion 132, 232 for heating the fuel heating portion 131. Further alternatively, the engine control portion 132, 232 may include all the functions of the heating control portion 133. The heating control portion 133 may include a part of the functions of the engine control portion 132, 232.

According to the first and second embodiments, in a case where the start of the engine 6 by the motoring motor 12 fails, the engine control portion 132, 232 decreases the fuel supply and decreases the electricity to the fuel heating portion 131 from the battery 11, 211 depending on the decrease amount of fuel supply. Alternatively, the engine control portion 132, 232 may not be necessary to decrease the electricity to the fuel heating portion 131 from the battery 11, 211 depending on the decrease amount of fuel supply.

According to the second embodiment, the engine control portion 232 increases the amount of electricity to the fuel heating portion 131 by gradually increasing the electricity to the fuel heating portion 131 from the battery 211 for a time period until the engine 6 starts in a case where the battery charge remaining R is equal to or smaller than the first threshold value C1 at the start of the engine 6. Alternatively, the engine control portion 232 may supply maximum power to the fuel heating portion 131 from the battery 211 for a time period until the engine 6 starts in a case where the battery charge remaining R is equal to or smaller than the first threshold value C1 at the start of the engine 6.

According to the first and second embodiments, the fuel heating portion 131 heats the fuel injected from the injector 64. Alternatively, the fuel heating portion 131 may heat fuel flowing through a fuel oil passage from a fuel tank.

According to the first and second embodiments, the control processing of each of the engine control portion 132, 232 and the heating control portion 133 is explained using the flowchart where operations are sequentially performed by following processing flows, i.e., a flow-driven type. Alternatively, the control processing performed by each control portion 132, 232, 133 may be an event-driven type. In this case, the control processing may be the event-driven type only or a combination of the event-driven type and the flow-driven type.

According to the aforementioned embodiments, a fuel heater 13, 213 including an engine 6 that is driven by combustion of air-fuel mixture including air and fuel supplied to a combustion chamber 63e within a cylinder 62a, a battery 11, 211 that stores electricity, and a motor 12, 212 that drives the engine 6 by the electricity supplied from the battery 11, 211, the fuel heater 13, 213 includes a fuel heating portion 131 heating the fuel with the electricity supplied from the battery 11, 211, and a controller 132, 133, 232 performing one of a first control by increasing the amount of electricity supplied from the battery 11, 211 to the fuel heating portion 131 and a second control by increasing heating time of the fuel by the fuel heating portion 131 for a time period until the engine 6 starts in a case where a battery charge remaining R of the battery 11, 211 is equal to or smaller than a remaining threshold value (first threshold value) C1 at a start of the engine 6. In this case, the controller 132, 133, 232 may be constituted by plural controllers or by a single controller.

The first threshold value C1 (remaining threshold value) is a battery lower limit serving as a lower limit of electricity for operating the fuel heating portion 131 and the engine 6. The engine control portion 132, 232 (controller) increases the amount of electricity supplied from the battery 11, 211 to the fuel heating portion 131 for the time period until the engine 6 starts in a case where the battery charge remaining R falls below the battery lower limit.

The engine control portion 132, 232 (controller) increases the amount of electricity to the fuel heating portion 131 for the time period until the engine 6 starts by specifying a target heating temperature of the fuel heating portion 131 to be higher than a temperature employed in a case where the battery charge remaining R exceeds the first threshold value C1, in a case where the battery charge remaining R is equal to or smaller than the first threshold value C1 (remaining threshold value) at the start of the engine 6.

The engine control portion 132, 232 (controller) increases the amount of electricity to the fuel heating portion 131 for the time period until the engine 6 starts by specifying time for supplying the electricity to the fuel heating portion 131 from the battery 11, 211 to be longer than time employed in a case where the battery charge remaining R exceeds the remaining threshold value C1, in a case where the battery charge remaining R is equal to or smaller than the remaining threshold value C1 at the start of the engine 6.

The engine control portion 132, 232 (controller) increases the heating time of the fuel by the fuel heating portion 131 by specifying timing to supply the fuel to be earlier than timing employed in a case where the battery charge remaining R exceeds the remaining threshold value C1, in a case where the battery charge remaining R is equal to or smaller than the remaining threshold value C1 at the start of the engine 6.

According to the second embodiment, the engine control portion 232 (controller) increases the amount of electricity to the fuel heating portion 131 for the time period until the engine 6 starts by gradually increasing the electricity from the battery 211 to the fuel heating portion 131 in a case where the battery charge remaining R is equal to or smaller than the remaining threshold value C1 at the start of the engine 6.

The engine control portion 132, 232 (controller) decreases a supply amount of the fuel and decreases the amount of electricity to the fuel heating portion 131 from the battery 11, 211 in response to the decrease of the supply amount of the fuel in a case where a start of the engine 6 by the motor 12 fails.

The fuel heater 13, 213 further includes an intake apparatus that supplies air to the combustion chamber within the cylinder. The intake apparatus includes a port portion into which fuel injected from an injection opening of an injector is introduced, and an intake passage provided at an inner side of the port portion to flow an air-fuel mixture including air and fuel supplied to the cylinder. The fuel heating portion includes a port heater that is provided along an inner surface of the port portion to vaporize the fuel introduced into the intake passage.

According to the embodiments, the engine control portion 132 (controller) decreases the amount of electricity supplied from the battery 11, 211 to the fuel heating portion 131 or stops the supply of electricity based on that the fuel heating portion 131 reaches a target heating temperature in a case where a power consumption of the battery 11, 211 caused by an electric component other than the fuel heating portion 131 continues for a predetermined time or more before the start of the engine 6.

The electricity is thus securely supplied to the electric component other than the fuel heating portion 131 by restraining the electricity to the fuel heating portion 131 from the battery 11, 211 after the fuel heating portion 131 achieves the target heating temperature before the start of the engine 6. Waste of power consumption of the battery 11, 211 is reduced accordingly. In a case where the engine 6 is started after the fuel heating portion 131 achieves the target heating temperature before the start of the engine 6, the fuel heating portion 131 is reheated in a state where the fuel heating portion 131 is warmed, which leads to effective heating of the fuel heating portion 131.

The engine control portion 132 (controller) is configured to start heating the fuel by the fuel heating portion 131 and to increase the amount of electricity from the battery 11, 211 to the fuel heating portion 131 based on the predetermined timing Tf before a vehicle driver performs an operation to start the engine 6.

Time where the fuel heating portion 131 is heated is thus elongated as much as possible up to start of the engine 6, so that the fuel heating portion 131 may securely achieve the target heating temperature at the time the engine 6 starts.

The engine control portion 132 (controller) at least obtains a control constant of a feedforward control based on information obtainable from the engine 6 during the start of the engine 6 in a case where the battery charge remaining R exceeds the first threshold value C1 (remaining threshold value), the feedforward control for restraining temperature decrease of the fuel heating portion 131 caused by fuel adhesion to the fuel heating portion 131 by increasing the amount of electricity to the fuel heating portion 131, the engine control portion 132 (controller) supplying the electricity to the fuel heating portion 131 to maintain the fuel heating portion 131 at a target heating temperature by a feedback control while increasing the amount of electricity to the fuel heating portion 131 by the feedforward control with the control constant.

The temperature decrease of the fuel heating portion 131 caused by disturbance is thus securely restrained by feedforward control. The fuel heating portion 131 may appropriately vaporize the fuel during the engine start (cranking).

The engine control portion 132 (controller) at least obtains a control constant of a feedforward control based on information obtainable from the engine 6 after the start of the engine, the feedforward control for restraining temperature decrease of the fuel heating portion 131 caused by fuel adhesion to the fuel heating portion 131 by increasing the amount of electricity to the fuel heating portion 131, the engine control portion 132 (controller) supplying the electricity to the fuel heating portion 131 to maintain the fuel heating portion 131 at a target heating temperature by a feedback control while increasing the amount of electricity to the fuel heating portion 131 by the feedforward control with the control constant.

The temperature decrease of the fuel heating portion 131 caused by disturbance is thus securely restrained by feedforward control. The fuel heating portion 131 may appropriately vaporize the fuel appropriately after the engine start (after the cranking).

The engine control portion 132 (controller) determines timing at which heating of fuel by the fuel heating portion 131 stops, on a basis of information obtainable from the engine 6 after the engine start.

The fuel heating portion 131 thus stops heating the fuel at timing at which the fuel vaporization is available with heat of the engine 6 without the fuel heating portion 131, by determining timing to stop heating of the fuel by the fuel heating portion 131 in accordance with the engine state. The fuel may be securely vaporized and waste of electricity from the battery 11, 211 to the fuel heating portion 131 may be reduced.

A fuel heating system according to the aforementioned embodiments includes the engine 6 that is driven by combustion of air-fuel mixture including air and fuel supplied to a combustion chamber within a cylinder, the battery 11, 211 that stores electricity, and the motor 12, 212 that drives the engine 6 by the electricity supplied from the battery 11, 211, and the fuel heater 13, 213 that heats the fuel supplied to the combustion chamber 63e within the cylinder 62a of the engine 6 with the electricity supplied from the battery 11, 211, the fuel heater 13, 213 including the fuel heating portion 131 heating the fuel with the electricity supplied from the battery 11, 211, the heating control portion 133 controlling the electricity supplied to the fuel heating portion 131, and the engine control portion 132 performing one of a first control by increasing the amount of electricity supplied from the battery 11, 211 to the fuel heating portion 131 and a second control by increasing heating time of the fuel by the fuel heating portion 131 for a time period until the engine 6 starts in a case where the battery charge remaining R of the battery 11, 211 is equal to or smaller than the first threshold value C1 (remaining threshold value) at the start of the engine 6.

According to the aforementioned fuel heating system, the fuel heater 13, 213 includes the engine control portion 132 that increases the electricity supplied from the battery 11, 211 to the fuel heating portion 131 or increases fuel heating time by the fuel heating portion 131 in a case where the battery charge remaining R is equal to or smaller than the first threshold value C1 (remaining threshold value) at the start of the engine 6 (right before the start of the engine 6). The fuel heating portion 131 thus stores heat beforehand up to start of the engine 6 for the amount corresponding to the increase of electricity supplied to the fuel heating portion 131 even when the battery charge remaining R is equal to or smaller than the first threshold value C1. The temperature of the fuel heating portion 131 is inhibited from excessively decreasing during the start of the engine 6 by the motor 12, 212. Additionally, the fuel heating portion 131 stores heat beforehand up to start of the engine 6 for the amount corresponding to the increase of fuel heating time, by increasing the fuel heating time of the fuel heating portion 131, even when the battery charge remaining R is equal to or smaller than the first threshold value C1. The temperature of the fuel heating portion 131 is inhibited from excessively decreasing during the start of the engine 6 by the motor 12, 212 accordingly. The fuel heating system that continuously and sufficiently heat the fuel by the fuel heating portion 131 during the cranking of the engine 6 by the motor 12, 212 is obtainable.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A fuel heater for a vehicle, the vehicle including an engine that is driven by combustion of air-fuel mixture including air and fuel supplied to a combustion chamber within a cylinder, a battery that stores electricity, and a motor that drives the engine by the electricity supplied from the battery, the fuel heater comprising:
a fuel heating portion heating the fuel with the electricity supplied from the battery; and
a controller performing one of a first control by increasing the amount of electricity supplied from the battery to the fuel heating portion and a second control by increasing heating time of the fuel by the fuel heating portion for a time period until the engine starts in a case where a battery charge remaining of the battery is equal to or smaller than a remaining threshold value at a start of the engine.

2. The fuel heater according to claim 1, wherein
the remaining threshold value is a battery lower limit serving as a lower limit of electricity for operating the fuel heating portion and the engine,
the controller increases the amount of electricity supplied from the battery to the fuel heating portion for the time period until the engine starts in a case where the battery charge remaining falls below the battery lower limit.

3. The fuel heater according to claim 1, wherein the controller increases the amount of electricity to the fuel heating portion for the time period until the engine starts by specifying a target heating temperature of the fuel heating portion to be higher than a temperature employed in a case where the battery charge remaining exceeds the remaining threshold value, in a case where the battery charge remaining is equal to or smaller than the remaining threshold value at the start of the engine.

4. The fuel heater according to claim 1, wherein the controller increases the amount of electricity to the fuel heating portion for the time period until the engine starts by specifying time for supplying the electricity to the fuel heating portion from the battery to be longer than time employed in a case where the battery charge remaining exceeds the remaining threshold value, in a case where the battery charge remaining is equal to or smaller than the remaining threshold value at the start of the engine.

5. The fuel heater according to claim 1, wherein the controller increases the heating time of the fuel by the fuel heating portion by specifying timing to supply the fuel to be earlier than timing employed in a case where the battery charge remaining exceeds the remaining threshold value, in a case where the battery charge remaining is equal to or smaller than the remaining threshold value at the start of the engine.

6. The fuel heater according to claim 1, wherein the controller increases the amount of electricity to the fuel heating portion for the time period until the engine starts by gradually increasing the electricity from the battery to the fuel heating portion in a case where the battery charge remaining is equal to or smaller than the remaining threshold value at the start of the engine.

7. The fuel heater according to claim 1, wherein the controller decreases a supply amount of the fuel and decreases the amount of electricity to the fuel heating portion from the battery in response to the decrease of the supply amount of the fuel in a case where a start of the engine by the motor fails.

8. The fuel heater according to claim 1, further comprising an intake apparatus that supplies air to the combustion chamber within the cylinder,
the intake apparatus including:
a port portion into which fuel injected from an injection opening of an injector is introduced; and
an intake passage provided at an inner side of the port portion to flow an air-fuel mixture including air and fuel supplied to the cylinder,
the fuel heating portion including a port heater that is provided along an inner surface of the port portion to vaporize the fuel introduced into the intake passage.

9. The fuel heater according to claim 1, wherein the controller decreases the amount of electricity supplied from the battery to the fuel heating portion or stops the supply of electricity based on that the fuel heating portion reaches a target heating temperature in a case where a power consumption of the battery caused by an electric component other than the fuel heating portion continues for a predetermined time or more before the start of the engine.

10. The fuel heater according to claim 1, wherein the controller is configured to start heating the fuel by the fuel heating portion and to increase the amount of electricity from the battery to the fuel heating portion based on a predetermined timing before a driver of the vehicle performs an operation to start the engine.

11. The fuel heater according to claim 1, wherein the controller at least obtains a control constant of a feedforward control based on information obtainable from the engine during the start of the engine in a case where the battery charge remaining exceeds the remaining threshold value, the feedforward control for restraining temperature decrease of the fuel heating portion caused by fuel adhesion to the fuel heating portion by increasing the amount of electricity to the fuel heating portion, the controller supplying the electricity to the fuel heating portion to maintain the fuel heating portion at a target heating temperature by a feedback control while increasing the amount of electricity to the fuel heating portion by the feedforward control with the control constant.

12. The fuel heater according to claim 1, wherein the controller at least obtains a control constant of feedforward control based on information obtainable from the engine after the start of the engine, the feedforward control for restraining temperature decrease of the fuel heating portion caused by fuel adhesion to the fuel heating portion by increasing the amount of electricity to the fuel heating portion, the controller supplying the electricity to the fuel heating portion to maintain the fuel heating portion at a target heating temperature by a feedback control while increasing the amount of electricity to the fuel heating portion by the feedforward control with the control constant.

13. The fuel heater according to claim 1, wherein the controller determines timing at which heating of the fuel by the fuel heating portion stops on a basis of information obtainable from the engine after the start of the engine.

14. A fuel heating system includes an engine that is driven by combustion of air-fuel mixture including air and fuel supplied to a combustion chamber within a cylinder, a battery that stores electricity, and a motor that drives the engine by electricity supplied from the battery, and a fuel heater that heats the fuel supplied to the combustion chamber within the cylinder of the engine with the electricity supplied from the battery, the fuel heater including the fuel heating portion heating the fuel with the electricity supplied from the battery, the heating control portion controlling the electricity supplied to the fuel heating portion, and an engine control portion performing one of a first control by increasing the amount of electricity supplied from the battery to the fuel heating portion and a second control by increasing heating time of the fuel by the fuel heating portion for a time period until the engine starts in a case where the battery charge remaining of the battery is equal to or smaller than the remaining threshold value at a start of the engine.
